(19) United States
(12) Patent Application Publication
(10) Pub. No.: US 2020/0098277 A1
(43) Pub. Date: Mar. 26, 2020

(54) INTERACTIVE DIGITAL VISION BOARD DEVICE AND METHOD

(71) Applicants: NTINA GOSSELIN, DELTA BC (CA); DENIS GOSSELIN, DELTA BC (CA)

(72) Inventors: NTINA GOSSELIN, DELTA BC (CA); DENIS GOSSELIN, DELTA BC (CA)

(21) Appl. No.: 16/143,331

(22) Filed: Sep. 26, 2018

(51) Int. Cl. G09B 5/02; G06F 3/0354; G06F 3/16; G06F 3/14; G06F 3/0488

(52) U.S. Cl. CPC G09B 5/02; G06F 3/03545; H04W 88/02; G06F 3/1454; G06F 3/04883; G06F 3/167

(57) ABSTRACT

A digital vision board system including a housing having a front-writing-surface (having a touch screen face able to display an interactive display of at least one image); and a back-surface integral with the front-writing-surface to form the housing; a tool for modifying at least one image on the front-writing-surface; a processor for processing data as related to the interactive display such that the at least one image is able to be located and interactively-displayed according to desired coordinates on the face; a modem to facilitate internet connectivity; and a powerer. The digital vision board system is in electrical communication with and controllable by a smart-electronic device in communication with the processor, the smart-electronic device using a software application; the digital vision board system serving to function to motivate and teach via the interactive display.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of education and demonstration, and telecommunications of existing art and more specifically relates to education and demonstration, and telecommunications formed by magnetic attraction between materials and programming control.

### RELATED ART

People of all ages, adults, youths and children, love to learn and acquire knowledge when given a positive learning environment, however this may not be easily attainable given the fact that people learn by different modes. Some of the known modes of learning include: the linguistic learner; the naturalist; the musical or rhythmic learner; the kinesthetic learner; the visual or spatial learner; the logical or mathematical learner; the interpersonal learner; and the intrapersonal learner. The fact that an instructor, teacher or educator may be presenting information and providing instruction to people with different learning aptitudes as well as with different learning styles may make teaching inefficient especially when trying to deliver difficult-to-understand content. Further, people may wish to learn from a variety of subject areas. For example, both children and adults who participate in sports in today's ultra-competitive modern society like to analyze their respective sport, check their relative ability and track their progress and improvements. While it is desirable for people to learn efficiently and to set goals as they keep track of assignments, deadlines, and schedules, conventional static presentation systems such as bulletin boards are typically not efficient in keeping focused attention for an extended period of time. A more fluid delivery system and method which may enable presentation and interaction with content in a manner which is more engaging to the reader would be desirable. Furthermore, such a delivery system and method may also lead to more efficient presentation, interaction and absorption of information, ideally leading to a more positive learning experience.

U.S. Pub. No. 2017/0206828 to Eric Michael Lunsford and Donald Gonzalez relates to a transparent whiteboard display. The described transparent whiteboard display has in one example implementation according to aspects of the disclosure, a transparent whiteboard display which causes digital content to be viewable on the transparent whiteboard display when the transparent whiteboard display is in a display mode. The transparent whiteboard display also causes analog content to be viewable on the transparent whiteboard display when the transparent whiteboard displays in a transparent mode.

### SUMMARY OF THE INVENTION

In view of the foregoing disadvantages inherent in the known education and demonstration, and telecommunications art, the present disclosure provides a novel interactive digital vision board device. The general purpose of the present disclosure, which will be described subsequently in greater detail, is to provide an interactive digital vision board device.

A digital vision board system is disclosed herein comprising: a housing including a front-writing-surface (having a face able to display an interactive display of at least one image); and a back-surface integral with the front-writing-surface to form the housing; a tool for modifying at least one image on the front-writing-surface; a processor for processing data as related to the interactive display such that the at least one image is able to be located and interactively-displayed according to desired coordinates on the (touch screen) face; a modem to facilitate internet connectivity; and a powerer. The digital vision board system is in electrical communication with and controllable by a smart-electronic device in communication with the processor, the smart-electronic device using a software application; the digital vision board system serving to function to motivate and teach via the interactive display.

A method of use for the digital vision board system is also disclosed herein, the method comprising the steps of: providing a digital vision board system comprising a housing including a front-writing-surface having a face able to display an interactive display of at least one image; and a back-surface integral with the front-writing-surface to form the housing; a tool for modifying at least one image on the front-writing-surface; a processor for processing data as related to the interactive display such that the at least one image is able to be located and interactively-displayed according to desired coordinates on the face, a modem to facilitate internet connectivity; and a powerer; and interacting with the processor causing the front-writing-surface to display the interactive display of the at least one image via the tool using the software application; wherein the tool preferably comprises a smartphone using the software application.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a digital themed vision board, constructed and operative according to the teachings of the present disclosure.

FIG. 1 is a perspective view of the digital vision board system during an ‘in-use’ condition, according to an embodiment of the disclosure.

FIG. 2 is a perspective view of the digital vision board system of FIG. 1, according to an embodiment of the present disclosure.

FIG. 3 is a perspective view of the digital vision board system of FIG. 1, according to an embodiment of the present disclosure.

FIG. 4 is a perspective view of the digital vision board system of FIG. 1, according to an embodiment of the present disclosure.

FIG. 5 is a flow diagram illustrating a method of use for the digital vision board system according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to education and demonstration, and telecommunications formed by magnetic attraction between materials and programming control and more particularly to an interactive digital vision board as used to improve electrical communication and serving to function to motivate and teach via interactive display.

Generally speaking, the present invention is able to be used with an Android/iOS application. Upon purchasing the vision board, the user is required to download and install a software application to their smartphone and/or tablet (or the like) in order to interact with the vision board. The application communicates with the vision board utilizing BLUETOOTH or similar technology and comprises the requisite internet connectivity. The user first creates a password protected profile in order to personalize and maintain private their own vision board and, because it is possible for many users to work with a single vision board, there will be no limit to the number of users who may create a profile.

Upon log in, the user will see their vision board display appear on their mobile device. From their mobile device, the user is able to upload images, video, audio and text to their vision board via the application's connectivity with the vision board. From the mobile device application, the user is able to utilize editing tools in order to perform the usual functions that will allow the user to customize the layout of their uploaded content that is being displayed on the vision board. All changes, additions and deletions that are made by the user to their vision board can be saved within the application and uploaded to the vision board. The user can save different iterations of their vision board layout so as to create different displays for different aspects of their lives and access past displays of their vision board.

The VISION BOARD, in preferred embodiments, measures 20″ by 24″ (smaller and larger versions are also available) and features both portrait and landscape views such that the user can mount the vision board either vertically or horizontally according to preference. A smaller version of the vision board is available for portability purposes. The vision board, as mentioned previously, includes BLUETOOTH technology and internet connectivity. The vision board may be powered much like any other wireless device and features cordless charging capability and there is no built-in AC cord on preferred embodiments. It comprises a built-in memory as well as portable storage connectivity from which the desired image, video, audio and text content can be uploaded to the vision board. Multiple versions of the vision board display can be saved to the internal memory of the vision board, to a portable storage device (such as USB or the like) or transferred to and from cloud-based storage. Users are able to print their vision board display from the portable storage device as the display will be saved in a printer friendly image format.

The vision board screen has touchscreen capability from which all of the features that are available through the use of the software application will also be available to the user, including qwerty keyboard. The vision board contains paint-like software from which the user is able to draw on the vision board so as to personalize the interactive experience. There are several pre-loaded options to choose from which allow the user to add borders, contour, frame and highlight any image that is uploaded to the vision board.

The vision board greets the user upon successful login and ‘speaks’ (audibilizes) one of several preloaded or personalized affirmations. The vision board's voice may have male, female and child/teen speech options. The vision board has several preloaded and customizable greetings from which to choose from which are specific to the time of day that the interaction between the vision board and the user is taking place. The user is able to speak commands to the vision board which may include multiple display and playback options. For example, the user is able to instruct the vision board to select from a number of different saved vision boards and display its content. User voice commands include the ability to instruct the vision board to display images while speaking affirmations or other customized written content that has been associated with such images.

Since the vision board is interactive, the user is able to choose, from among several options, the manner in which each image in the display collage is separately brought forward and displayed along with any audio and text that has been linked or associated with such image.

The user is also able to instruct the vision board through voice command to playback pre-loaded and customizable background music such as mood and energy lifting music and sounds. The user is also able to instruct the vision board through voice command to display background light and colors that provide vitamin D and other mood/energy uplifting properties. Such features are pre-loaded but also fully customizable by the user. The user, or a party authorized by the user, will also be able to upload sports, music and dance media content.

The vision board may include a stylus pen that will also allow the user to manipulate the content that is displayed on the vision board. One unique feature of the stylus is that it allows the user to freehand trace around any content that is on the board and cut, copy, paste, or delete such content. This is not a cropping feature, rather it is a freehand feature that allows the user to simulate the use of a pair of scissors (as a function) in order to cut out content from the display of the vision board. The stylus can therefore cut out and insert freehand cut out content into the display of the vision board. The stylus also includes handwriting recognition software which allows the user to either include handwritten text anywhere on the display screen of the vision board and/or allows the user to alternatively convert the handwriting into standard keyboard text. Further, the user is also able to fully communicate with, interact with, and operate the vision board through voice command and voice recognition technology.

The vision board has several pre-loaded and fully customizable meditation programs and brainwave audio programs from which the user can choose. Such meditation programs will be able to include lighting, music, audio, video and images as pre-loaded or as specifically customized by the user. Such meditation programs have pre-set time options from which the user may select as well as a fully customizable time setting to be programmed by the user. The vision board may also include several preloaded yoga programs that the user is able to select from using the voice command feature. Again, the user will also be able to upload personalized and customized yoga programs to the vision board, as desired. Once instructed by the user through voice command, the vision board logs the user off and audibilizes a salutation and positive affirmations. Such salutations and affirmations may vary depending on the time of the day and may include multiple pre-loaded options as well as the ability to fully customize greetings and affirmations.

The present invention in alternate embodiments may display illuminated digitally transmitted images and logos. The whiteboard is controlled via an Android and iOS compatible software application which allows the user to fully customize the digitally displayed illuminated images and logos. Illumination may be used to indicate that content is available, content has changed, or alternatively, to operate as a light either permanently or intermittently. The non-illuminated whiteboard serves as a vision board from which parents can inspire their children to follow their visions (adults can use the device as well). Various attachments can be affixed to the board with the use of the included 3D magnets; the frame being able to have the 3D magnets attached thereto. The screen is not magnetic and may be borderless for ‘borderless display’. The frame is optional.

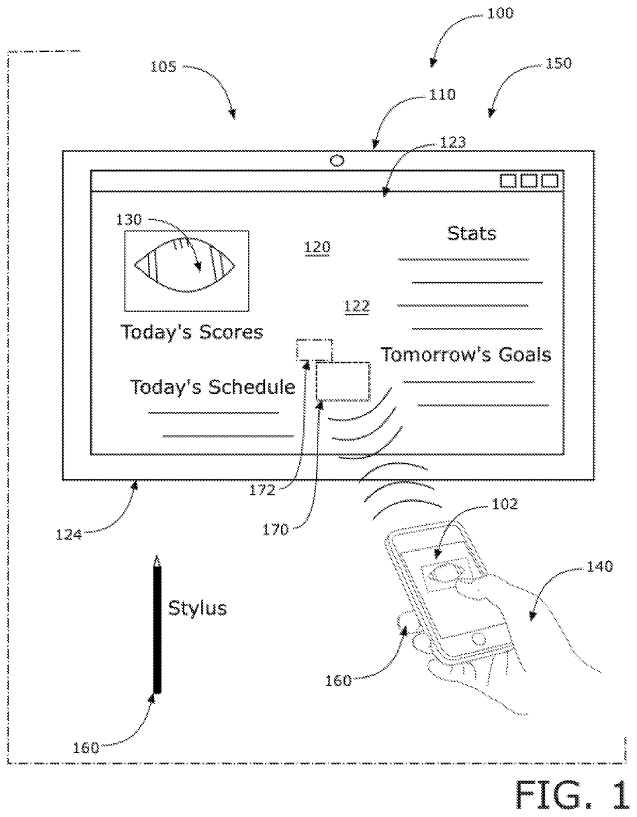

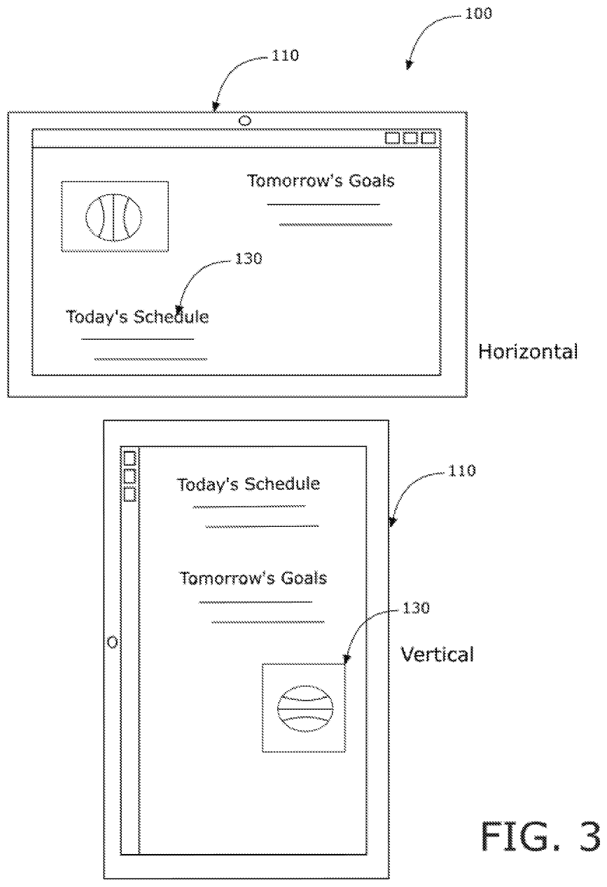

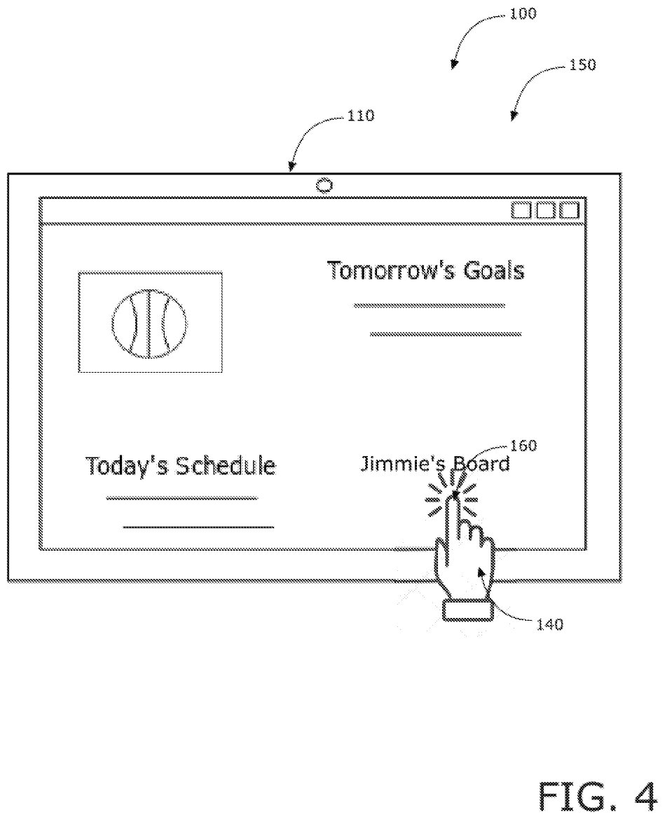

Referring now more specifically to the drawings by numerals of reference, there is shown in FIGS. 1-4, various views of a digital vision board system 100.

FIG. 1 shows a digital vision board system 100 during an ‘in-use’ condition 150, according to an embodiment of the present disclosure. Here, the digital vision board system 100 may be beneficial for use by a user 140 to provide an efficient means for interactive learning and to promote setting and attaining of goals. As illustrated, the digital vision board system 100 may include a housing 110 including a front-writing-surface 120 (having a face 122 able to display an interactive display of at least one image 130); and a back-surface 124 integral with the front-writing-surface 120 to form the housing 110; a tool 160 for modifying at least one image on the front-writing-surface 120; a processor 170 for processing data as related to the interactive display such that the at least one image is able to be located and interactively-displayed according to desired coordinates on the face 122; a modem 172 to facilitate internet connectivity; and a powerer.

The digital vision board system 100 is in electrical communication with and controllable by a smart-electronic device 102 in communication with the processor 170; the smart-electronic device 102 using a software application. As designed, the digital vision board system 100 serves to function to motivate and teach via the interactive display. Those with ordinary skill in the art will now appreciate that upon reading this specification and by their understanding of the art of communicating, processing and displaying as described herein, methods of displaying via electronic means will be understood by those knowledgeable in such art. Powering may be via any suitable means such as batteries, AC means or the like.

According to one embodiment, the digital vision board system 100 may be arranged as a kit 105. In particular, the digital vision board system 100 may further include a set of instructions. The instructions may detail functional relationships in relation to the structure of the digital vision board system 100 such that the digital vision board system 100 can be used, maintained, or the like, in a preferred manner.

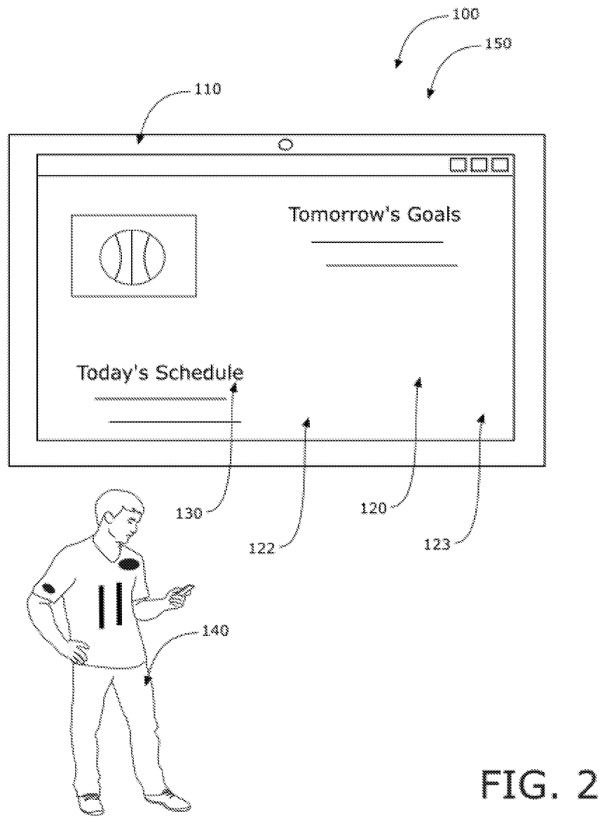

FIGS. 2-4 show various views of the digital vision board system 100 of FIG. 1, according to an embodiment of the present disclosure.

The housing 110 in preferred embodiments comprises a translucent-housing; wherein the translucent-housing is able to be illuminated via illuminating means (lights or the like). As designed, the translucent-housing is useful as a night-light for partially illuminating an inner volume of a room, for example during low light periods. The at least one image 130 is able to be displayed intermittently as to time intervals and as to the coordinates as per user-preferred pre-programming. For example, the at least one image 130 may comprise sports team logos or highlight reels that move across the screen (face 122). The housing 110 of the digital vision board system 100 is able to be mounted horizontally and alternately vertically. The digital vision board system 100 may further comprise a memory storage, as previously mentioned. The digital vision board system 100 may further comprise portable storage connectivity such as USB or suitably equivalent technology and voice recognition means such that the interactive display is able to be voice-manipulated. In this way the present invention is interactive by nature.

The at least one image 130 displayed on the face 122 of the front-writing-surface 120 matches the at least one image 130 displayed on the smart-electronic device 102 and is able to be controlled via the software application; wherein the smart-electronic device 102 comprises a cellular phone for example or tablet or the like. The powerer preferably comprises cordless charging capability. The face 122 comprises a touch-screen 123 in preferred embodiments able to be manipulated via touch from the tool, wherein the tool comprises a stylus and alternately the tool comprises a finger. Those with ordinary skill in the art will now appreciate that upon reading this specification and by their understanding of the art of touch screen technology as described herein, methods of touch manipulation will be understood by those knowledgeable in such art.

In alternate embodiments, the front-writing-surface 120 comprises a semi-rigid-surface such that the front-writing-surface 120 can be written on when the tool comprises an erasable marker (not shown). The front-writing-surface 120 comprising the semi-rigid-surface is eraseable such that markings made by the erasable marker are able to be removed and re-written on and erased repeatedly. The front-writing-surface 120 comprises ferrous material such that 3-D magnetic items are able to be coupled to, and removed from, the front-writing-surface 120 when desired.

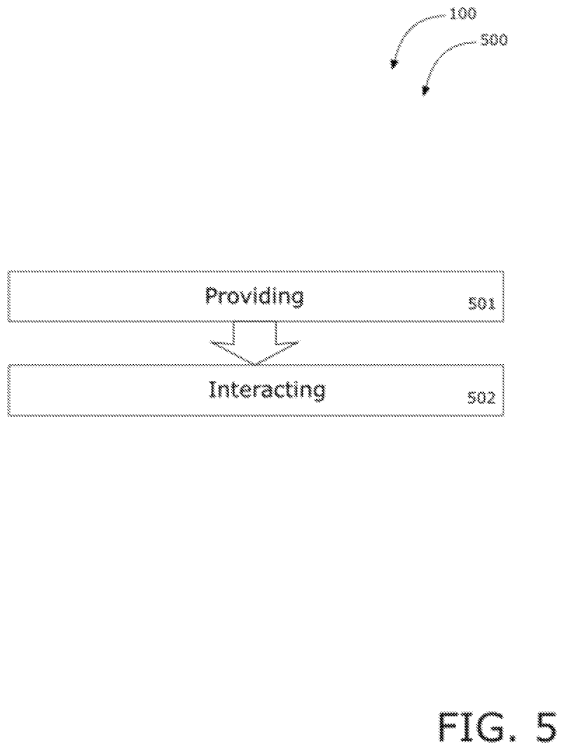

FIG. 5 is a flow diagram illustrating a method of use 500 for the digital vision board system 100 according to an embodiment of the present disclosure. The method 500 comprises the steps of: step one 501 providing a digital vision board system comprising a housing including a front-writing-surface having a face able to display an interactive display of at least one image; and a back-surface integral with the front-writing-surface to form the housing; a tool for modifying at least one image on the front-writing-surface; a processor for processing data as related to the interactive display such that the at least one image is able to be located and interactively-displayed according to desired coordinates on the face, a modem to facilitate internet connectivity; and a powerer; and step two 502 interacting with the processor causing the front-writing-surface to display the interactive display of the at least one image via the tool using the software application; wherein the tool preferably comprises a smartphone using the software application but may comprise a stylus, finger or other.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for displaying or programming are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent and is set forth in the appended claims:

1. A digital vision board system comprising:
a housing including
a front-writing-surface having a face able to display an interactive display of at least one image; and
a back-surface integral with said front-writing-surface to form said housing;
a tool for modifying at least one image on said front-writing-surface;
a processor for processing data as related to said interactive display such that said at least one image is able to be located and interactively-displayed according to desired coordinates on said face,
a modem to facilitate internet connectivity; and
a powerer;
wherein said digital vision board system is in electrical communication with and controllable by a smart-electronic device in communication with said processor, said smart-electronic device using a software application, said digital vision board system serving to function to motivate and teach via said interactive display.

2. The digital vision board system of claim 1, wherein said front-writing-surface comprises a semi-rigid-surface such that said front-writing-surface can be written on when said tool comprises an erasable marker.

3. The digital vision board system of claim 2, wherein said front-writing-surface comprising said semi-rigid-surface is eraseable such that markings made by said erasable marker are able to be removed and re-written on and erased repeatedly.

4. The digital vision board system of claim 3, wherein said front-writing-surface comprises ferrous material such that 3-D magnetic items are able to be removable coupled to said front-writing-surface when desired.

5. The digital vision board system of claim 1, wherein the housing comprises a translucent-housing.

6. The digital vision board system of claim 5, wherein the translucent-housing is able to be illuminated.

7. The digital vision board system of claim 6, wherein the translucent-housing is useful as a night-light.

8. The digital vision board system of claim 1, wherein the at least one image is able to be displayed intermittently as to time intervals and as to said coordinates as per user-preferred pre-programming.

9. The digital vision board system of claim 8, further comprising a memory storage.

10. The digital vision board system of claim 9, wherein the at least one image displayed on said face of said front-writing-surface matches said at least one image displayed on said smart-electronic device and able to be controlled via said software application.

11. The digital vision board system of claim 1, wherein the smart-electronic device comprises a cellular phone.

12. The digital vision board system of claim 1, wherein the housing is able to be mounted horizontally and alternately vertically.

13. The digital vision board system of claim 1, wherein the powerer comprises cordless charging capability.

14. The digital vision board system of claim 1, further comprising portable storage connectivity.

15. The digital vision board system of claim 1, wherein the face comprises a touch-screen able to be manipulated via touch from said tool, wherein said tool comprises a stylus and alternately said tool comprises a finger.

16. The digital vision board system of claim 1, further comprising voice recognition means such that said interactive display is able to be voice-manipulated.

17. A digital vision board system comprising:
a housing including
a front-writing-surface having a face able to display an interactive display of at least one image; and
a back-surface integral with said front-writing-surface to form said housing;
portable storage connectivity;
a tool for modifying at least one image on said front-writing-surface;
a processor for processing data as related to said interactive display such that said at least one image is able to be located and interactively-displayed according to desired coordinates on said face,
a modem to facilitate internet connectivity;
a memory storage; and
a powerer;
wherein the housing comprises a translucent-housing;
wherein the translucent-housing is able to be illuminated;
wherein the translucent-housing is useful as a night-light;
wherein the housing is able to be mounted horizontally and alternately vertically;
wherein the at least one image is able to be displayed intermittently as to time intervals and as to said coordinates as per user-preferred pre-programming;
wherein the at least one image displayed on said face of said front-writing-surface matches said at least one image displayed on a smart-electronic device and is able to be controlled via said software application;
wherein the smart-electronic device comprises a cellular phone;
wherein the powerer comprises cordless charging capability;
wherein the face comprises a touch-screen able to be manipulated via touch from said tool, wherein said tool comprises a stylus and alternately said tool comprises a finger; and
wherein said digital vision board system is in electrical communication with and controllable by said smart-electronic device in communication with said processor, said smart-electronic device using a software application, said digital vision board system serving to function to motivate and teach via said interactive display.

18. The digital vision board system of claim 17, further comprising set of instructions; and
wherein the digital vision board system is arranged as a kit.

19. A method of use for the digital vision board system, the method comprising the steps of:
providing a digital vision board system comprising:
a housing including
a front-writing-surface having a face able to display an interactive display of at least one image; and
a back-surface integral with said front-writing-surface to form said housing;
a tool for modifying at least one image on said front-writing-surface;
a processor for processing data as related to said interactive display such that said at least one image is able to be located and interactively-displayed according to desired coordinates on said face,
a modem to facilitate internet connectivity; and
a powerer;
wherein said digital vision board system is in electrical communication with and controllable by a smart-electronic device in communication with said processor, said smart-electronic device using a software application, said digital vision board system serving to function to motivate and teach via said interactive display; and
interacting with said processor causing said front-writing-surface to display said interactive display of said at least one image via said tool using said software application.

20. The method of claim 19, wherein said tool comprises a smartphone using said software application.
